(19) United States
(12) Patent Application Publication
(10) Pub. No.: US 2020/0398238 A1
(43) Pub. Date: Dec. 24, 2020

(54) MULTIFUNCTIONAL BLENDING EQUIPMENT

(71) Applicant: YANTAI JEREH PETROLEUM EQUIPMENT & TECHNOLOGIES CO., LTD., Yantai (CN)

(72) Inventors: Jifeng Zhong, Yantai (CN); Weiwei Liu, Yantai (CN); Kun Zhang, Yantai (CN); Xincheng Li, Yantai (CN); Jixin Wang, Yantai (CN); Yipeng Wu, Yantai (CN); Sheng Chang, Yantai (CN); Bingnan Lv, Yantai (CN); Shuwei Li, Yantai (CN); Chuanlu Bao, Yantai (CN)

(21) Appl. No.: 16/837,096

(22) Filed: Apr. 1, 2020

(30) Foreign Application Priority Data
Jun. 21, 2019 (CN) 201910540695.5

(51) Int. Cl. B01F 15/02; B01F 3/08; B01F 15/00

(52) U.S. Cl. CPC B01F 15/026; B01F 15/00422; B01F 3/088

(57) ABSTRACT

The present invention discloses multifunctional blending equipment, including a clear water supply system, a spray system, a mixing system, a powder material storage and transport system, a mixing tank, a discharge system, and an electrical control system. A path of the clear water supply system is connected to the mixing tank by a tubing, and another path is connected to an input end of the spray system. An output end of the spray system is connected in parallel to more than two mixing systems. The quantity of the powder material storage and transport systems is equal to that of the mixing systems. Each powder material storage and transport system is correspondingly connected to one mixing system. Output ends of the more than two mixing systems are all connected to the mixing tank. An output end of the mixing tank is connected to the discharge system. The clear water supply system, the spray system, the mixing system, the powder material storage and transport system, the mixing tank, and the discharge system are controlled by the electrical control system. Beneficial effects: The blending equipment can implement various blending processes at the same time, is integrally skid mounted, and occupies a small area.

### TECHNICAL FIELD

The present invention relates to the technical field of fracturing in oil and gas fields, and specifically to multifunctional blending equipment.

### BACKGROUND

Well drilling is an indispensable process in oil exploration nowadays. A well drilling fluid and a well washing fluid are usually used during well drilling. At present, the two fluids are mostly prepared on a fixed site. Fracturing is a major approach to increase production of oil and gas fields. Currently, a large amount of fracturing base fluids are required during fracturing work all over the world, especially on shale gas fracturing sites. A lot of base fluids are still prepared on fixed sites in China. Preparation sites of the two fluids occupy large areas, require many workers, and are inadequately automated. In view of such requirements, the present invention provides a set of multifunctional fluid preparation equipment that can prepare a variety of fluids and is widely applicable, thereby resolving problems such as a large occupied area and inadequate automation during fluid preparation on a fixed site. The equipment may work in place of an original fixed site and may prepare fluids in real time on a well drilling site or a fracturing site. The equipment may match driving forms such as a diesel-driven form, an electric-drive fluid form, and an electric drive form according to various construction requirements and different matching capabilities of on-site electricity to adapt to requirements on different well sites, has a compact structure, and can be conveniently transported and moved. Based on the foregoing characteristics, the equipment effectively resolves various problems of fluid preparation on a fixed site.

### SUMMARY

To overcome deficiencies in the prior art, an objective of the present invention is to provide multifunctional blending equipment. In the blending equipment, more than two mixing systems are connected in parallel, and each mixing system is equipped with a separate powder material addition system. One or two or more mixing systems are selectively turned on to implement separate blending of a fluid or simultaneous blending of various fluids. On this basis, two ends of the blending equipment are selectively connected to downstream equipment or a storage tank to implement real-time blending or batch blending. The blending equipment is integrally skid mounted, is conveniently moved, and occupies a small area.

The objective of the present invention is achieved by the following technical measures: Multifunctional blending equipment includes a clear water supply system, a spray system, a mixing system, a powder material storage and transport system, a mixing tank, a discharge system, and an electrical control system. A path of the clear water supply system is connected to the mixing tank by a tubing, and another path is connected to an input end of the spray system, an output end of the spray system is connected in parallel to more than two mixing systems, the quantity of the powder material storage and transport systems is equal to that of the mixing systems, each powder material storage and transport system is correspondingly connected to one mixing system, output ends of the more than two mixing systems are all connected to the mixing tank, an output end of the mixing tank is connected to the discharge system, and the clear water supply system, the spray system, the mixing system, the powder material storage and transport system, the mixing tank, and the discharge system are controlled by the electrical control system.

Further, the multifunctional blending equipment is driven in a purely electrical manner or/and in an electric-drive fluid manner or/and in a motor-driven manner.

Further, the multifunctional blending equipment further includes a liquid replenishing valve, the liquid replenishing valve is connected in parallel with the clear water supply system, and the liquid replenishing valve is connected to the spray system.

Further, the clear water supply system, the spray system, the mixing system, the powder material storage and transport system, the mixing tank, the discharge system, and the electrical control system are integrally skid mounted on a skid base.

Further, the multifunctional blending equipment is further provided with a folding arm crane configured for adding powder materials, and the folding arm crane is skid mounted on the skid base.

Further, corresponding metering devices are disposed according to different powder materials to be added.

Further, the clear water supply system includes a clear water valve, a suction pump, and a flow meter, and the clear water valve, the suction pump, and the flow meter are sequentially connected to be separately connected to the mixing tank and the spray system.

Further, the clear water supply system further includes a liquid level control valve, and the liquid level control valve is disposed on a tubing directly connected to the mixing tank.

Further, the type of a mixer in the mixing system is chosen according to characteristics of powder materials to be added.

Further, when large-grain powder materials need to be added to the powder material storage and transport system, the powder material storage and transport system may be additionally provided with a crusher.

Compared with the prior art, beneficial effects of the present invention are as follows: 1. In the blending equipment, more than two mixing systems are connected in parallel, and each mixing system is equipped with a separate powder material addition system. One or two or more mixing systems are selectively turned on to implement separate blending of a fluid or simultaneous blending of various fluids. On this basis, two ends of the blending equipment are selectively connected to downstream equipment or a storage tank to implement real-time blending or batch blending. 2. The blending equipment may drive related execution components in a purely electrical manner or/and in an electric-drive fluid manner or/and in a motor-driven manner, and is more energy saving and more environmentally friendly than the original case in which only an engine-driven manner can be used, thereby reducing exhaust emission and work costs. 3. The blending equipment is integrally skid mounted, is conveniently moved, and occupies a small area. 4. In the blending equipment, the quantity and the types of mixers may be flexibly set to satisfy requirements of various blending processes.

The present invention will be described below in detail with reference to the accompanying drawings and specific implementations.

### BRIEF DESCRIPTION OF THE DRAWINGS

FIG. 1 is a process flowchart of multifunctional blending equipment.

Where: 1. clear water valve, 2. suction pump, 3. flow meter, 4. mixing tank, 5. liquid level control valve, 6. spray pump, 7. guar gum powder storage and transport system, 8. industrial salt storage and transport system, 9. valve, 10. first mixer, 11. valve, 12. valve, 13. second mixer, 14. valve, 15. discharge pump, 16. flow meter, 17. valve, and 18. liquid replenishing valve.

### DESCRIPTION OF THE EMBODIMENTS

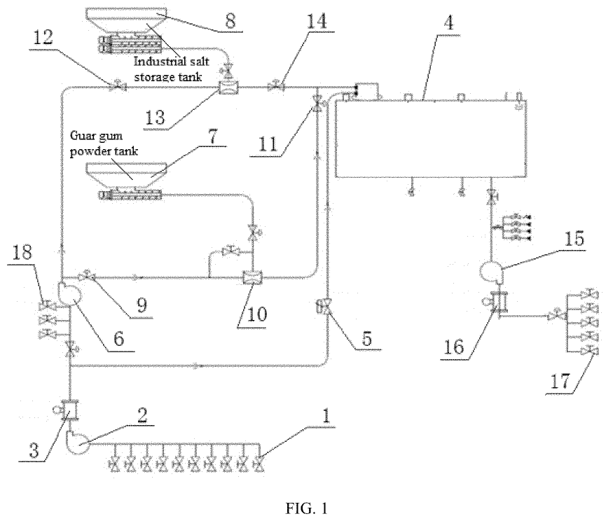

As shown in FIG. 1, multifunctional blending equipment includes a clear water supply system, a spray system, a mixing system, a powder material storage and transport system, a mixing tank 4, a discharge system, a folding arm crane, and an electrical control system. A path of the clear water supply system is connected to the mixing tank 4 by a tubing, and another path is connected to an input end of the spray system. An output end of the spray system is connected in parallel to more than two mixing systems. The quantity of the powder material storage and transport systems is equal to that of the mixing systems. Each powder material storage and transport system is correspondingly connected to one mixing system. Output ends of the more than two mixing systems are all connected to the mixing tank 4. An output end of the mixing tank 4 is connected to the discharge system. The folding arm crane is configured for adding powder materials to the powder material storage and transport system. When the powder materials in the powder material storage and transport system are used up, with the use of the folding arm crane, the time and labor required to add a large amount of powder materials can be greatly reduced. The clear water supply system, the spray system, the mixing system, the powder material storage and transport system, the mixing tank 4, and the discharge system are controlled by the electrical control system, and is driven in a purely electrical manner or/and in an electric-drive fluid manner or/and in a motor-driven manner. Purely electric drive blending fluid supply equipment of the blending equipment can adequately satisfy electrical requirements of work equipment on well sites. Compared with conventional engine-driven equipment, the purely electric drive equipment is more energy saving and more environmentally friendly, thereby reducing fuel consumption and exhaust emission. The clear water supply system, the spray system, the mixing system, the powder material storage and transport system, the mixing tank 4, the folding arm crane, the discharge system, and the electrical control system are integrally skid mounted on a skid base. A plurality of mixing systems and the powder material storage and transport systems that correspond to the mixing systems one by one can satisfy requirements of various blending processes. A valve is disposed at each of an input end and an output end of a mixer in each mixing system. The mixing system can be turned on or off by adjusting the valves at the input end and the output end.

According to the conditions of materials, necessary pretreatment equipment such as a large-grain salt crusher may be disposed in the powder material storage and transport system to crush large-size materials into small-size materials to facilitate subsequent procedures such as mixing.

During blending different powder materials, corresponding metering devices are disposed according to different powder materials to be added. For example, a transport amount may be metered with a rotational speed, or an electronic scale may be used to assist measurement.

The clear water supply system includes a clear water valve 1, a suction pump 2, and a flow meter 3. The clear water valve 1, the suction pump 2, and the flow meter 3 are sequentially connected to be separately connected to the mixing tank 4 and the spray system. There are a plurality of clear water valves 1 to satisfy a requirement of rapidly transporting clear water during blending. A liquid level control valve 5 disposed on a tubing directly connected to the mixing tank 4 can control a transport amount of clear water.

The spray system includes a fluid inlet valve and a spray pump 6. The fluid inlet valve configured to control on or off of the spray system is connected in series with the spray pump 6.

The multifunctional blending equipment further includes a liquid replenishing valve 18. The liquid replenishing valve 18 is connected in parallel with the clear water supply system. The liquid replenishing valve 18 is connected to the spray pump 6. There may be one or more liquid replenishing valves 18.

The powder material storage and transport system includes a guar gum powder storage and transport system 7, an industrial salt storage and transport system 8, and the like, to satisfy process requirements such as the preparation of a fracturing fluid, the preparation of a well servicing fluid, and the preparation of a well washing fluid on well sites.

The mixing system includes a guar gum mixing system, an industrial salt mixing system, and the like. The guar gum powder storage and transport system 7 is connected to the guar gum mixing system. The industrial salt mixing system is connected to the industrial salt storage and transport system 8. The guar gum mixing system includes a valve 9, a first mixer 10, and a valve 11. The valve 9, the first mixer 10, and the valve 11 are sequentially connected. The valve 9 is connected to the spray pump 6. The valve 11 is connected to the mixing tank 4. The industrial salt mixing system includes a valve 12, a second mixer 13, and a valve 14. The valve 12 is connected to the spray pump 6. The valve 14 is connected to the mixing tank 4. The types of the first mixer 10 and the second mixer 13 are set according to the properties of powder materials to be added, so that the mixers better adapt to powder materials and the powder materials are mixed more adequately.

The discharge system includes a discharge pump 15, a flow meter 16, a valve 17, and the like. The discharge pump 15, the flow meter 16, and the valve 17 are sequentially connected. There are a plurality of valves 17.

The electrical control system includes a variable-frequency drive cabinet and a control cabinet.

The multifunctional blending equipment further includes a liquid additive system. The liquid additive system is connected to the suction pump 2 or the discharge pump 15. Liquid additive ingredients that need to be added are added via the liquid additive system.

Embodiment 1: Separate blending of one material. For example, during blending of a guar gum fluid, a clear water source is joined to the clear water valve 1. The industrial salt storage and transport system 8, the valve 12, the second mixer 13, the valve 14, and the liquid replenishing valve 18 are turned off. The remaining components in the equipment are at working state. A path of clear water enters the mixing tank 4 through the liquid level control valve 5, and another path of clear water enters the first mixer 10 through the spray pump 6. The guar gum powder storage and transport system 7 transports powder materials. After mixing in the first mixer 10, the mixing fluid is transported to the mixing tank 4 for further mixing and is finally discharged through the discharge pump 15, the flow meter 16, and the valve 17.

Embodiment 2: Simultaneous blending of various materials. For example, a guar gum powder and an industrial salt are blended simultaneously. Compared with Embodiment 1, the industrial salt storage and transport system 8, the valve 12, the second mixer 13, and the valve 14 are all opened to enter a normal working state. Clear water is sprayed by the spray pump 6 to separately enter the first mixer 10 and the second mixer 13. After premixing with added powder materials of the respective corresponding guar gum powder storage and transport system 7 and industrial salt storage and transport system 8, the mixed fluids flow together into the mixing tank 4 for further mixing, and are evenly mixed to be discharged through the discharge system. Alternatively, the valves (the valve 9, the valve 11, the valve 12, and the valve 14) at both ends of the first mixer 10 and both ends of the second mixer 13 are omitted. The powder material storage and transport system adds or does not add powder materials to a corresponding mixer to control the blending manner (separate blending or blending of more than two powder materials). For example, during separate blending of guar gum, it is only necessary to make the guar gum powder storage and transport system 7 transport powder materials to the system. In this case, other mixer systems transport only clear water.

When a suction centrifugal pump works and different liquids need to be additionally added to the equipment, the liquids may be added through the liquid replenishing valve in front of the spray system. When the suction centrifugal pump does not work, the valve between the spray system and the suction pump may be turned off to separately use the spray system to work, to satisfy mixing in small-flow circulation, thereby reducing the power consumption of the equipment.

During real-time mixing, a fluid inlet end and a fluid outlet end of the multifunctional blending equipment are connected to corresponding upstream and downstream equipment. During batch mixing, the fluid inlet end and the fluid outlet end of the multifunctional blending equipment are connected to a storage tank to implement the circulation of a blending fluid.

1. Multifunctional blending equipment, comprising a clear water supply system, an injection system, more than two mixing systems, more than two powder storage and delivery systems, a mixing tank, a discharge system, and an electrical control system, wherein one path of the clear water supply system is piped into the mixing tank, and another path of the clear water supply system is connected to an input end of the injection system; an output end of the injection system is connected in parallel with the more than two mixing systems, the number of the powder storage and delivery systems is equal to that of the mixing systems, each powder storage and delivery system is correspondingly connected to one mixing system, output ends of the more than two mixing systems are all connected into the mixing tank; an output end of the mixing tank is connected to the discharge system, and the clear water supply system, the injection system, the more than mixing systems, the powder storage and delivery systems, the mixing tank, and the discharge system are controlled by the electrical control system.

2. The multifunctional blending equipment according to claim 1, wherein the multifunctional blending equipment is driven electrically or/and electro-hydraulically or/and driven by engine.

3. The multifunctional blending equipment according to claim 1, wherein the multifunctional blending equipment further comprises one or more replenishing valves, the replenishing valves are connected in parallel with the clear water supply system, and the replenishing valves are connected to the injection system.

4. The multifunctional blending equipment according to claim 1, wherein the clear water supply system, the injection system, the mixing system, the powder storage and delivery systems, the mixing tank, the discharge system, and the electrical control system are integrally skid mounted on a skid base.

5. The multifunctional blending equipment according to claim 4, wherein the multifunctional blending equipment is further provided with a folding crane configured for adding powder, and the folding crane is skid mounted on the skid base.

6. The multifunctional blending equipment according to claim 5, wherein corresponding metering devices are set according to the different powder materials added.

7. The multifunctional blending equipment according to claim 1, wherein the clear water supply system comprises multiple clear water valves, a suction pump, and a flow meter, and the clear water valves, the suction pump, and the flow meter are connected successively and then connected into the mixing tank and the injection system respectively.

8. The multifunctional blending equipment according to claim 7, wherein the clear water supply system further comprises a level control valve, and the level control valve is located on the pipeline directly connected with the mixing tank.

9. The multifunctional blending equipment according to claim 1, wherein the type of the mixers in the mixing systems is selected according to the characteristics of the powders added.

10. The multifunctional blending equipment according to claim 1, wherein when large granular powders are added through the powder storage and delivery system, a crusher can be additionally arranged on the powder storage and delivery system.
